(19) United States
(12) Patent Application Publication
(10) Pub. No.: US 2017/0172081 A1
(43) Pub. Date: Jun. 22, 2017

(54) MANUFACTURE USED WITH RECYCLED CUPS AND MATERIALS

(71) Applicants: ROGER ANTON SRAMEK, Tiburon, CA (US); Gregory Stirling Sramek, Mill Valley, CA (US); Kendall LaRayen Sramek, Medford, MA (US)

(72) Inventors: ROGER ANTON SRAMEK, Tiburon, CA (US); Gregory Stirling Sramek, Mill Valley, CA (US); Kendall LaRayen Sramek, Medford, MA (US)

(21) Appl. No.: 14/975,651

(22) Filed: Dec. 18, 2015

(51) Int. Cl. A01G 27/02; B65D 51/28; B65D 47/06; A01G 9/02

(52) U.S. Cl. CPC A01G 27/02; A01G 9/021; B65D 51/28; B65D 47/06

(57) ABSTRACT

The present invention is a manufacture for nurturing plants from a propagative source. The manufacture includes a holder for holding the propagative source, a tail extending from the holder for feeding water to the holder and the propagative source. The manufacture is positioned in a cover for a cup where the cover is inverted so as to support soil and so as to support the manufacture and where the cover has a hole and where the tail extends through the hole and into the cup.

### BACKGROUND OF THE INVENTION

This invention relates to a manufacture used with recycled containers for nurturing plants from a propagative source and particularly to the use, and/or re-use, of disposable cups and related products of the type used by vendors to serve coffee and other beverages.

The containers include “to go” coffee, tea, Slurpee, soup and other ingredients. The containers that might otherwise be discarded are used or reused in plant propagation for gardening/forestry purposes. The containers and related products after use for nurturing plants from a propagative source are also recycled and/or composted. Specifically, cups, sleeves, lids, stirring rods, straws, napkins and trays can all be used in seed germination, sprouting, early growth and care and, finally, as mulch in their final trans-planting for full maturation or for ongoing use as bonsai or other growth containers.

Coffee shops, fast food shops and other vendors of beverages sell their hot coffee, tea, soups and other liquids in cups made of paper, cardboard, plastics, Styrofoam and polymers or some combinations thereof. Often, an insulating sleeve, a lid, a stirring rod, a straw, a napkin or carrying trays for multiple containers are furnished. Similarly, cold beverages are sold over the counter or bar, from vending machines or in stores in case lots or other quantities.

These cups and are frequently printed or labeled with a company logo, name of manufacturer, advertising message, and instructions for use or warnings. Often, these messages convey some reference to the recycled content and/or the “green” philosophy of the seller.

While the cups, lids and other materials are food grade materials, the sleeves and trays are often made from new materials, but are also commonly made of recycled post-consumer fibers, recycled paper, cardboard or other recycled materials or a combination of these with newly produced materials.

While the cups come in many sizes, they are typically made to contain between 8 ounces and 20 ounces or more. The lids, sleeves trays are sized to fit the range of cup sizes.

The inner surface and/or outer surface of the cups and sleeves may be smooth, corrugated, waffle grid or other textured finish. Each may also be coated to combat leakage.

In most instances, these cups and ancillary items are thrown away at the time the consumer finishes the beverage, sometimes placed into a separate recycling bin. However, placement of a recycle bin in a coffee shop, for example, where the bulk of the business involves takeout of beverages, means most of the containers will end up in mixed waste and never recycled, ending up in a landfill. Even if they are recycled along with other paper or plastics goods, they are seldom, if ever, reused.

There is a need to use and re-use and re-purpose cups, lids, sleeves, stirring rods, straws, napkins and carrying trays, originally manufactured for beverage containers and ancillary items, for planting and nurturing plants in gardening, urban farming or forestry and then further using them for mulch, sequestration, pest control, mechanical support or other nurturing uses.

The need is to reuse these cups, sleeves and so on individually or in combination, modified or unmodified for a range of purposes having to do with gardening and forestry.

In consideration of the above background, there is a need for improved manufactures suitable for use with recycled containers and other materials for nurturing plants from a propagative source.

### SUMMARY

The present invention is a manufacture for nurturing plants from a propagative source. The manufacture includes a holder for holding the propagative source, a tail extending from the holder for feeding water to the holder and the propagative source.

In one embodiment, the holder holds one or more seeds as the propagative source.

In one embodiment, the holder includes soil.

In one embodiment, the holder includes a packet containing soil.

In one embodiment, the manufacture is positioned in a cover for a cup where the cover has a hole and where the tail extends through the hole and into the cup.

In one embodiment, the cup contains water and wherein the tail extends through the hole into the water whereby water is fed to holder for germinating the propagative source.

In one embodiment, a stirrer is inserted into the hole for controlling the flow of water.

In one embodiment, the manufacture is positioned in a cover for a cup where the cover is inverted so as to support soil and so as to support the manufacture and where the cover has a hole and where the tail extends through the hole and into the cup.

In one embodiment, a napkin is placed on a surface of the cover where a portion of the napkin protrudes through the hole.

In one embodiment, the tail contains fertilizer for feeding a plant germinated from the propagative source.

The foregoing and other objects, features and advantages of the invention will be apparent from the following detailed description in conjunction with the drawings.

### BRIEF DESCRIPTION OF THE DRAWINGS

FIG. 1 depicts a top view of a manufacture having a holder for holding a propagative source and having a tail extending from the holder for feeding water.

FIG. 2 depicts a front view of the manufacture of FIG. 1.

FIG. 3 depicts a front view of the manufacture of FIG. 2 with the tail bent at an angle.

FIG. 4 depicts a top view of another embodiment of a manufacture having a holder for holding a propagative source and having a tail extending from the holder for feeding water.

FIG. 5 depicts a front view of the manufacture of FIG. 4.

FIG. 6 depicts a front view of the manufacture of FIG. 5 with the tail bent at an angle.

FIG. 7 depicts a sectional end view of the manufacture of FIG. 5.

FIG. 8 depicts a top view of another embodiment of a manufacture having a holder for holding a propagative source and having a tail extending from the holder for feeding water.

FIG. 9 depicts a front view of the manufacture of FIG. 8 with the tail bent at an angle.

FIG. 10 depicts a top view of another embodiment of a manufacture having a holder for holding a propagative source and having a tail with embedded fertilizer extending from the holder for feeding water.

FIG. 11 depicts a front view of a two-part dirt packet.

FIG. 12 depicts a front view of the two-part dirt packet of FIG. 11 with the parts superimposed over seeds.

FIG. 13 depicts a top view of the manufacture of FIG. 1 having seeds for heirloom tomatoes.

FIG. 14 depicts a top view of the manufacture of FIG. 1 having seeds for arugula.

FIG. 15 depicts a top view of the manufacture of FIG. 1 having seeds for spinach.

FIG. 16 depicts a top view of the manufacture of FIG. 1 having seeds for zucchini.

FIG. 17 depicts a top view of the manufacture of FIG. 1 having seeds for butter lettuce.

FIG. 18 depicts a top view of the manufacture of FIG. 1 having seeds for petunias.

FIG. 19 depicts a bottom view of the manufacture of FIG. 1 having advertisements for a vendor that may wish to sell or give away the manufacture to promote recycling.

FIG. 20 depicts a top view of a cover.

FIG. 21 depicts a front view of the cover of FIG. 20.

FIG. 22 depicts a front view of a cup for use with the cover of FIG. 20.

FIG. 23 depicts a front view of a cup of FIG. 22, the inverted cover of FIG. 21 and the manufacture of FIG. 6.

FIG. 24 depicts a front view of a cup of FIG. 23, the inverted cover of FIG. 21 and the manufacture of FIG. 9.

FIG. 25 depicts a front view of a cup of FIG. 23, the inverted cover of FIG. 21 and the manufacture of FIG. 9 with water in the cup expanding the manufacture.

FIG. 26 depicts a front view of a cup, the inverted cover and the manufacture where seeds have established roots and sprouts.

FIG. 27 depicts a front view of a cup of FIG. 23, the inverted cover of FIG. 21 and the manufacture of FIG. 3 with loose dirt over the manufacture.

FIG. 28 depicts a front view of a stirring rod.

FIG. 29 depicts a side view of the stirring rod of FIG. 28.

FIG. 30 depicts a front view of the inverted cover of FIG. 20 together with the manufacture of FIG. 9 and the stirring rod of FIG. 29.

FIG. 31 depicts a top view of another cover.

FIG. 32 depicts a front view of the cover of FIG. 31.

FIG. 33 depicts a front view of a cup of FIG. 25 with the inverted cover of FIG. 21 and the manufacture of FIG. 9 together with the cover of FIG. 32.

FIG. 34 depicts a front view of the cup of FIG. 22, the inverted cover of FIG. 32 and the manufacture of FIG. 8.

FIG. 35 depicts a side view of the cup, the inverted cover and the manufacture of FIG. 34.

FIG. 36 depicts the side view of the cup, the inverted cover and the manufacture of FIG. 35 with the manufacture expanded.

FIG. 37 depicts a front view of the cup of FIG. 22, the inverted cover of FIG. 32, a soil packet and a napkin.

FIG. 38 depicts a top view of an insulating sleeve.

FIG. 39 depicts a front view of a cup together with the insulating sleeve of FIG. 38.

FIG. 40 depicts a front view of the cup and the insulating sleeve of FIG. 39 positioned in another cup.

### DETAILED DESCRIPTION

The present invention makes use and re-use of cups, lids, sleeves, stirring rods, straws, napkins and carrying trays which are typically originally manufactured for beverage containers and ancillary items. The invention includes the use or re-use and recycling of each or a combination of these items and/or modification of them resulting in new and novel uses, or reuses, for them. Together with other uses detailed herein, these uses generally include:

Paper Cups:

As a container for soil, water, fertilizers, mulch etc. for planting of seeds, bulbs, clippings, sprouts and the like to initiate and promote growth.

Perforating the bottom of the cup for proper aeration and drainage of the soil once the cup has been filled with soil to the appropriate level for further growth of the plant(s).

As protection against snails, squirrels, birds, gophers and other predators who would eat the seeds or new vegetation.

To prevent evaporation, evaporative cooling and sudden temperature changes that could retard plant growth.

Slit or perforated and transplanted along with the contained plant(s) so that the root system is not disturbed in the planting and the paper or other cup material decomposes to enhance the organic content of the soil. Also, in this context, prevents certain predatory creatures from attacking the roots of the plants in the early days.

Cups made with a biodegradable plastic liner are planted without concern for the plastic sheath left when cups are planted.

Placing a cup inside of another cup to prevent leakage.

Plastic Cups:

All of the uses for paper cups above (except for decomposition as mulch).

Placing a paper cup inside of the plastic one to protect the paper cup, prevent leakage onto treasured surfaces and, in connection with the domed plastic lid, as a snail, bird and other predator guard in the seed germination or early sprouting stage.

Used as seed starter or a planter itself, the root growth rate and structure may be observed through the clear plastic cup.

Used as a water storage unit to allow, prior to use with plants, the evaporation of Halogens and other chemicals which might be harmful to seeds or delicate plant tissue.

Used as water storage and to mix in soil additives which promote root/plant growth.

Used as “permanent” planter for bonsai or other plants where root growth is intended to be restricted.

Use inside of a paper cup, bag or other enclosure to shield from sunlight and prevent algae from growing and consuming valuable nitrogen.

Lids:

As temporary storage of seeds being readied or treated prior to planting.

As a cup lid to reduce evaporation, to protect seeds or new plants against consumption by snails, squirrels, birds etc.

As an insert to hold a nut, large seed at water level to initiate and promote root growth.

As a starter tray inverted and placed atop the cup (filled nearly to the brim with water) to keep the soil moist during germination and sprouting moments. A layer of paper material or napkin under the soil layer with a strip cut away, but still connected to, the napkin and extending through the sip hole into the water helps wick the water into place and keep the soil moist.

As a measuring and application scoop for small amounts of soil, water, fertilizer.

Lids can be made of paper, with or without a biodegradable plastic coating so that these could be both reused and recycled as they are slit and planted along with the sprouted seeds and soil already contained within. As temporary containers for seeds while they are being collected, dried or given a preliminary soaking prior to planting.

Bubble Tops (Lids):

As a snail guard or barrier to keep out squirrels, birds, rats or other predators which could steal seeds or otherwise damage or kill plants.

As a top for plastic cup water storage container to allow gas exchange but reduce evaporation while the water is being conditioned.

As a mini-greenhouse to keep wind away from fragile shoots and reduce dehydration of the soil mantle on top.

Used on top of an inverted cup lid, seeds and soil as a mini-greenhouse.

Inverted, used to support a seed such as an avocado, peach or buckeye slightly below or at the water level in the cup to induce germination and spouting.

With folded paper sleeve or napkin blocking the approximately 1″ diameter hole in the lid, the inverted lid is filled with soil and seed(s); the water in the cup supporting it wicks its way up to the soil via the sleeve or napkin, keeping it moist.

Sleeves:

Placed inside of the cup, one or more of the sleeves can be used to trap or position a seed, or seeds between the cup and sleeve surfaces slightly below, at or above the water level of the cup.

Folded into a half or full saddle, supports soil, napkin or sleeve material, seeds etc. above the water level to promote and initiate seed germination and root formation; sleeve attracts water from the water level when that level is slightly above the bottom of the sleeve.

As a means of creating a moist environment for seed germination and spouting by virtue of the capillarity potential of the material and its “wicking” water up from the cup and saturating the sleeve.

Cut up onto pieces, the sleeves may be mixed as mulch in the soil, used on top of the inverted lids atop of the cups to wick water across the surface to keep soil moist.

May be used on the perimeter of an inverted lid as a screen and support members to protect small sprouts from wind or from falling over in their early fragile state.

As compost or mulch as it decomposes while still in the cup or as organic material contributor when the plant is relocated to larger container or to a garden spot, having left the sleeve in place from the beginning.

Rolled up and inserted through the approximately 1″ diameter hole in an inverted bubble top lid, the sleeve acts as a wick, bringing the water to the soil from the cup below as in 4.F.

Stirring Rods:

Used to suspend a seed (e.g., avocado) above the water in a cup by inserting them through the wall of the cup in a supporting “scaffold” to hold the seed.

Used to prop up small, fragile plants for proper support and orientation toward the sun.

If wooden, placed in the container, it may be used as a labeling stick to identify plant varieties, planting and transplanting dates, from the beginning and ongoing until finally it becomes composted.

Straws:

Straws open, or with one end stapled or pinched partly shut may be used as a “pipette” while watering delicate seed mantles without disturbing the topsoil and seeds just beneath. Using two at the same time increases the quantity of water, but not the velocity.

Inserted along the wall of the cup placed within a second cup as in 1.G. or through the sip hole of an inverted lid, the straw acts as a means of aeration of the soil below or as a means of filling or refilling the cup with water or nutrients without disturbing the soil.

Carrying Trays:

As a means of keeping the cups from being blown over by the wind, especially when the cups have not yet been weighted with water or soil.

Propping up one side, the tray with cups resting within may be used as a means of angling the cups so that the sun shines more directly on the top of the cup or soil.

As composted or mulch material when mixed into the soil when the plant is relocated to larger container or to a garden spot.

Spent Napkins and Wrappers:

When not badly soiled, napkins can be twisted, crumpled, folded or wadded and mixed into the soil as compost and as a moisture retention medium.

When folded to a proper (rectangular) configuration, they may be used beneath soil of sandwiched between or within layers of soil as a moisture wicking and retention medium.

Spent Coffee Grounds:

When mixed with potting soil, or with basaltic rock dust, make excellent growing soil for all sorts of plants.

When mixed with lime or other ingredients, the pH may be adjusted to meet the plants' requirements.

Seed Cards:

Seeds are imbedded in paper which is rolled and inserted on edge into a cup with a small amount (½″) of water, which will induce the seeds to sprout. These cards with sprouts protruding from them then have soil filled in around the base where the water once stood. Roots will reach down to the soil and plants will begin accelerated growth.

A seed card shaped and sized such that it fits flat in the inverted lid, also having a ¼″-½″ wide “tail” attached for insertion through the sip hole in the lid down into the water in the cup to wick water up from the cup to wet the seed card and soil. The seed card is also sold as a separate product and imprinted with an advertising message, logo etc.

Pyrolytically Derived Carbon:

Carbon derived from pyrolytic (high heat in absence of oxygen) decomposition of waste tires or other rubber products, or wood products, when mixed with the soil, becomes a seat or mantle for growth of fungi useful in promoting and maintaining proper root growth and plant nutrition. Over time, this carbon increases organic content of the soil.

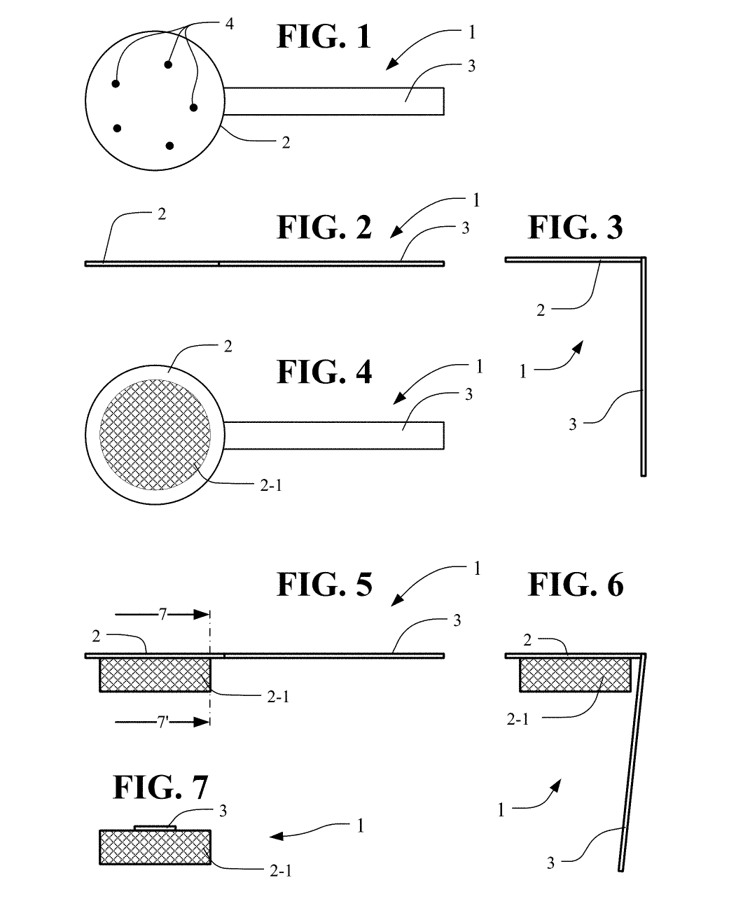

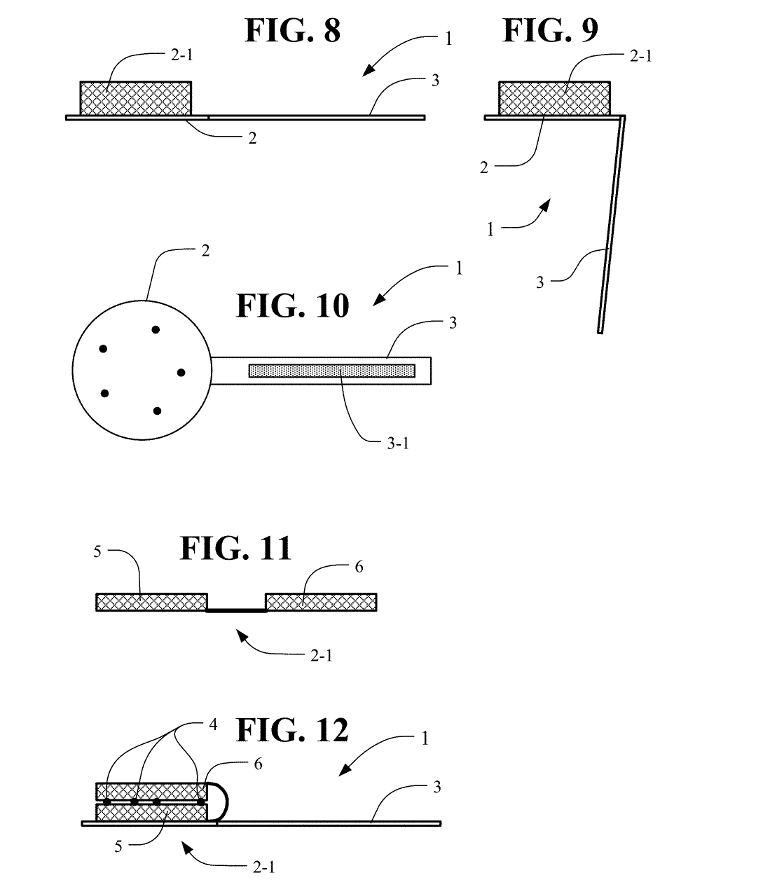

In FIG. 1, a top view of a manufacture 1 having a holder 2 for holding a propagative source and having a tail 3 extending from the holder 2 for feeding water. In the FIG. 1 embodiment, the propagative source is one or more seeds 4. The manufacture 1 is typically formed of paper that in the FIG. 1 embodiment is approximately 0.08 inch thick. The holder 2 in the FIG. 1 embodiment is circular with a diameter of approximately 1.5 inches. The tail 3 in the FIG. 1 embodiment is rectangular with a width of approximately 0.3 inch and a length of approximately 3 inches. None of the dimensions are critical and wide variations are possible. The holder 2 includes one or more seeds impregnated or otherwise attached to the holder material. Preferably, the paper or other material used for the manufacture 1 is readily biodegradable and readily absorbs water and acts as a wick or other water transport.

In FIG. 2, a front view of the manufacture 1 of FIG. 1 is shown including a holder 2 for holding a propagative source such as the seeds 4 in FIG. 1 and having a tail 3 extending from the holder 2 for feeding water.

In FIG. 3, a front view of the manufacture 1 of FIG. 2 with the tail 3 bent at an angle of approximately 90 degrees or more.

In FIG. 4, a top view of another embodiment of a manufacture 1 having a holder 2 for holding a propagative source and having a tail 3 extending from the holder 2 for feeding water. The manufacture 1 is typically formed of paper that in the FIG. 1 embodiment is approximately 0.08 inch thick. The holder 2 in the FIG. 4 embodiment is circular with a diameter of approximately 1.5 inches. The tail 3 in the FIG. 4 embodiment is rectangular with a width of approximately 0.3 inch and a length of approximately 3 inches. None of the dimensions are critical and wide variations are possible. The holder 2 includes a soil packet 2-1 which includes growing soil in a compressed form in the shape of a disk measuring approximately 1 inch in diameter and approximately 0.25 inch thick in the dry form. The soil packet 2-1 is attached to the paper forming the manufacture 1. The packet 2-1 has an outer mesh for keeping the soil contained. Typically, one or more seeds, like seeds 4 in FIG. 1, are impregnated into the packet 2-1 and the seeds are the propagative source. The holder 2 and the packet 2-1 receive water through the tail 3 when the tail is immersed in water.

In FIG. 5, a front view of the manufacture 1 of FIG. 4 is shown including a holder 2 and a soil packet 2-1 for holding a propagative source such as the seeds 4 in FIG. 1 and having a tail 3 extending from the holder 2 for feeding water.

In FIG. 6, a front view of the manufacture 1 of FIG. 5 with the tail 3 bent at an angle of approximately 90 degrees or more.

In FIG. 7, a sectional end view of the manufacture 1 of FIG. 5 taken along section line 7-7′ in FIG. 5 and having soil packet 2-1 and tail 3.

In FIG. 8, a top view of another embodiment of a manufacture 1 is shown including a holder 2 and a soil packet 2-1 for holding a propagative source such as the seeds 4 in FIG. 1 and having a tail 3 extending from the holder 2 for feeding water. In FIG. 8, the soil packet 2-1 is on the opposite side of the holder 2 relative to the soil packet position in FIG. 5.

In FIG. 9, a front view of the manufacture 1 of FIG. 8 with the tail 3 bent at an angle of approximately 90 degrees or more.

In FIG. 10, a top view of another embodiment of a manufacture 1 having a holder 2 for holding a propagative source and having a tail 3, with embedded fertilizer 3-1, extending from the holder 2 for feeding water.

In FIG. 11, a front view of a two-part dirt packet 2-1 is shown having a first dirt packet 5 and a second dirt packet 6. The packets 5 and 6 each has an outer mesh for keeping the soil contained. Typically, one or more seeds, like seeds 4 in FIG. 1, are impregnated into the packets 5 and 6 and the seeds are the propagative source. In some embodiments, no seeds are embedded into the packets 5 and 6.

In FIG. 12, a front view of the two-part dirt packet 2-1 of FIG. 11 is shown with the packets 5 and 6 superimposed over seeds 4. In FIG. 12 embodiment, seeds may or may not be embedded in the packets 5 and 6.

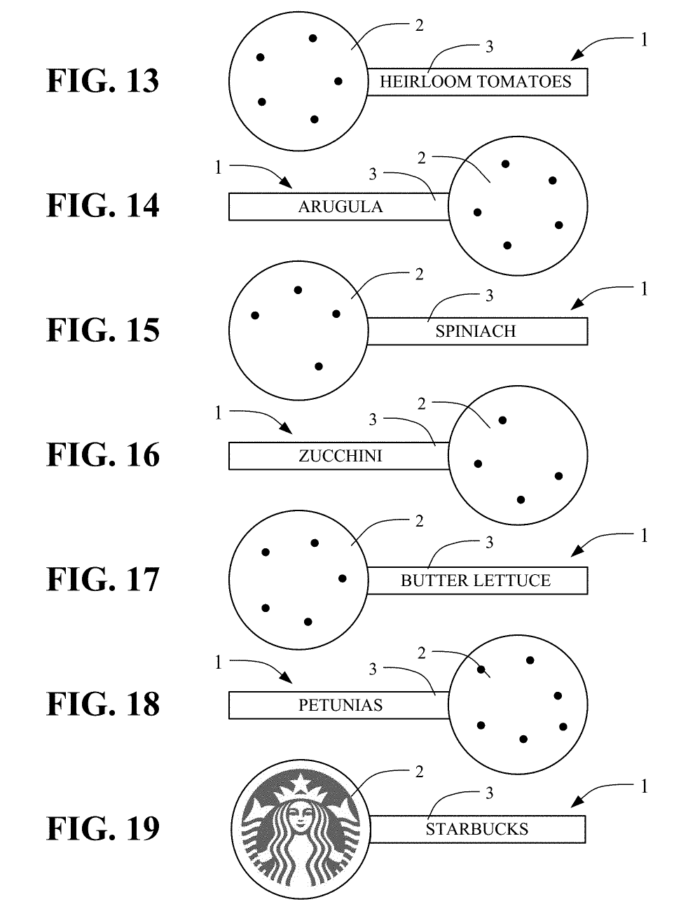

In FIG. 13, a top view of the manufacture 1 of FIG. 1 having seeds for heirloom tomatoes.

In FIG. 14, a top view of the manufacture 1 of FIG. 1 having seeds for arugula.

In FIG. 15, a top view of the manufacture 1 of FIG. 1 having seeds for spinach.

In FIG. 16, a top view of the manufacture 1 of FIG. 1 having seeds for zucchini.

In FIG. 17, a top view of the manufacture 1 of FIG. 1 having seeds for butter lettuce.

In FIG. 18, a top view of the manufacture 1 of FIG. 1 having seeds for petunias.

In FIG. 19, a bottom view of the manufacture 1 of FIG. 1 having advertisements for a vendor that may wish to sell or give away the manufacture 1 to promote recycling.

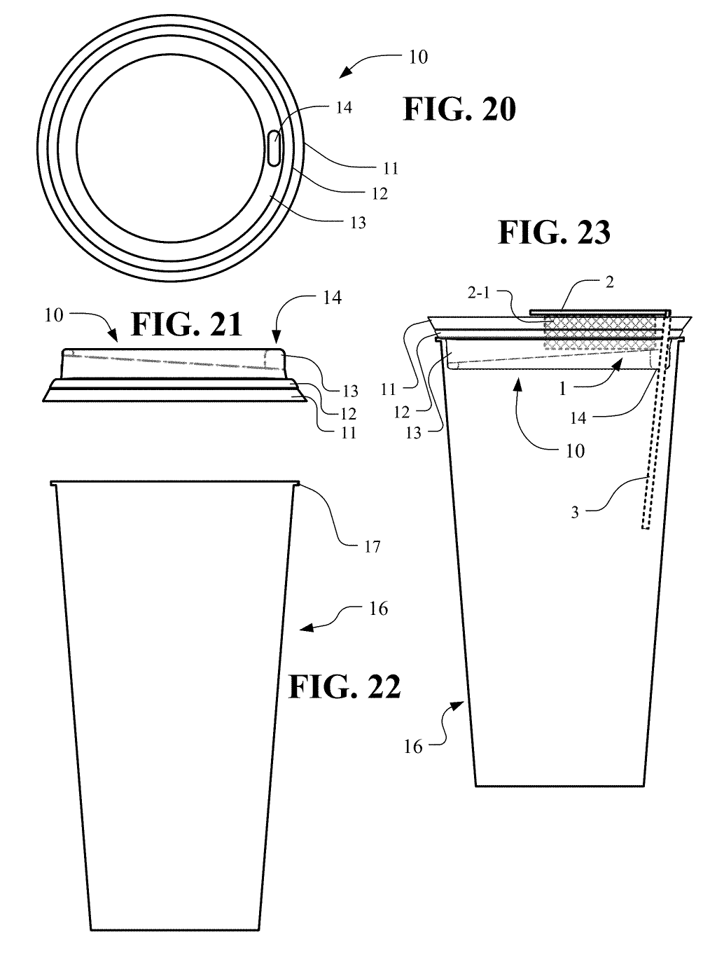

In FIG. 20, a top view of a cover 10 is shown. The cover 10 includes a first rim 11, a second rim 12 and an inner rim 13. The inner rim 13 includes a sipping hole 14.

In FIG. 21, a front view of the cover 10 of FIG. 20 is shown. The cover 10 includes a first rim 11, a second rim 12 and an inner rim 13. The inner rim 13 includes a sipping hole 14. The first rim 11 and the second rim 12 are formed to provide a seal on a matching cup.

In FIG. 22, a front view of a cup 16 for use with the cover 10 of FIG. 20 is shown. The cup 16 includes an upper rim 17 designed to fit within the first rim 11 and to be stopped by the second rim 12 of the cover 10 of FIG. 21 when the cover is used in a drinking mode. The cover 10 thus forms a seal with the cup 16 in the drinking mode. The hole 14 allows liquids sealed in the cup 16 by the cover 10 to pass through the hole 14.

In FIG. 23, a front view is shown of a cup 16 of FIG. 22, the inverted cover of FIG. 21 and the manufacture 1 of FIG. 6. The tail 3 of the manufacture 1 extends through the hole 14 in the cover 10 into the cup 16. The holder 2 and the dirt packet 2-1 remain on top of the inverted cover 10. The cover 10 includes a first rim 11, a second rim 12 and an inner rim 13. In the upside down garden mode of FIG. 23, the rims 11 and 12 prevent the cover 10 from falling into the cup 16 while the rim 13 extends down into the cup 16.

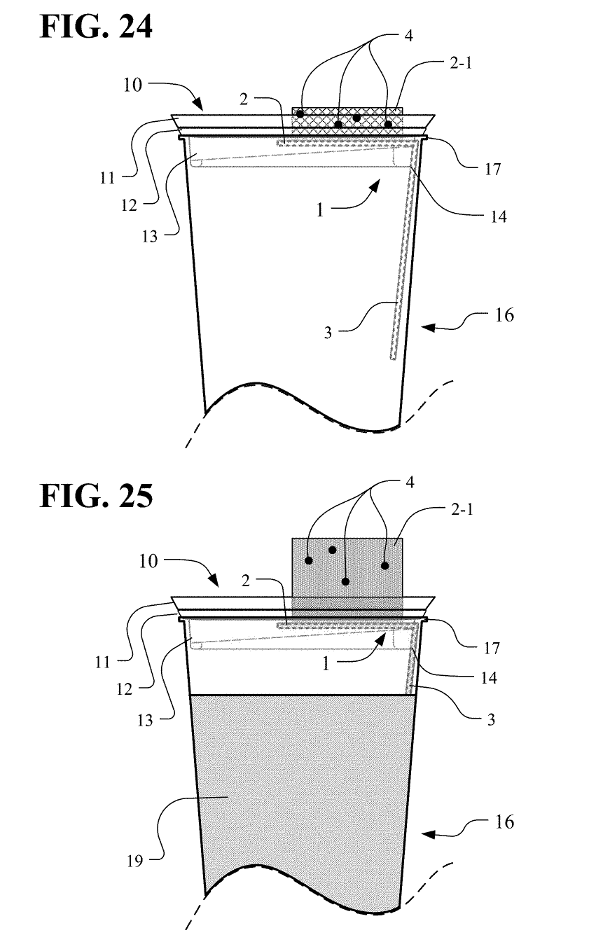

In FIG. 24, a front view is shown of the cup 16 of FIG. 22, the inverted cover of FIG. 21 and the manufacture 1 of FIG. 9. The tail 3 of the manufacture 1 extends through the hole 14 in the cover 10 into the cup 16. The holder 2 and the dirt packet 2-1 remain on top of the inverted cover 10. The cover 10 includes a first rim 11, a second rim 12 and an inner rim 13. In the upside down garden mode of FIG. 24, the rims 11 and 12 prevent the cover 10 from falling into the cup 16 while the rim 13 extends down into the cup 16. The dirt packet 2-1 includes embedded seeds 4.

In FIG. 25, a front view of a cup of FIG. 23, the inverted cover of FIG. 21 and the manufacture 1 of FIG. 9 with water 19 in the cup expanding the packet 2-1 of the manufacture 1. The water 19 in the cup 16 travels through the tail 3 to the holder 2 and the packet 2-1 and around the seeds 4 for germination of the seeds 4.

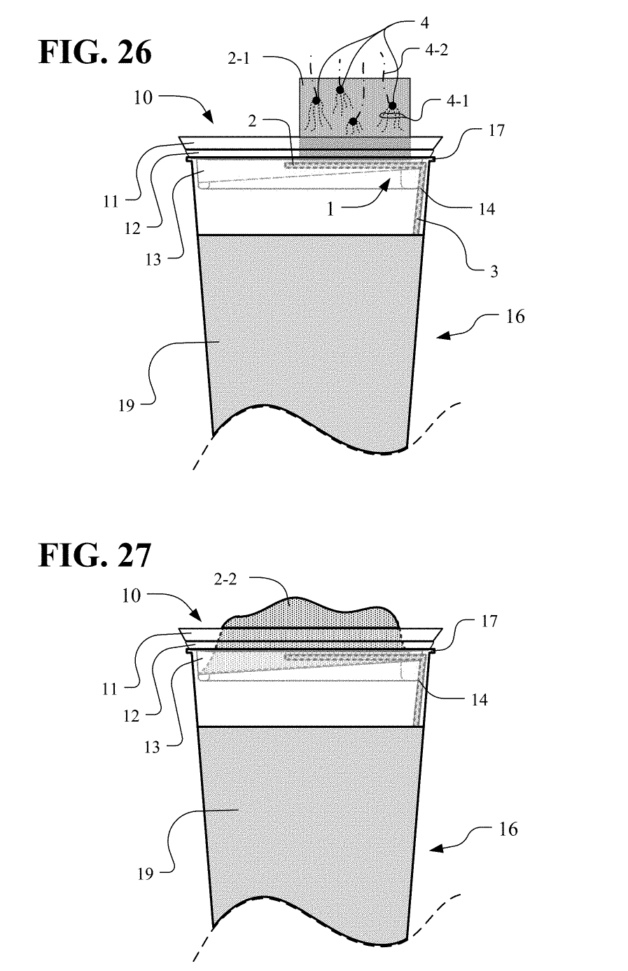

In FIG. 26, a front view is shown of the cup 16, the inverted cover 10 and the manufacture 1 of FIG. 25. The packet 2-1 due to being fed by water 19 has expanded in height approximately by a factor of five.

FIG. 27, a front view of a cup 16 of FIG. 23, the inverted cover of FIG. 21 and the manufacture 1 of FIG. 3 with loose dirt 2-2 over the manufacture 1. In an alternate embodiment, the dirt 2-2 is first deposited and then the manufacture 1 is installed on top of the dirt. Also, additional dirt can be deposited on top of manufacture 1.

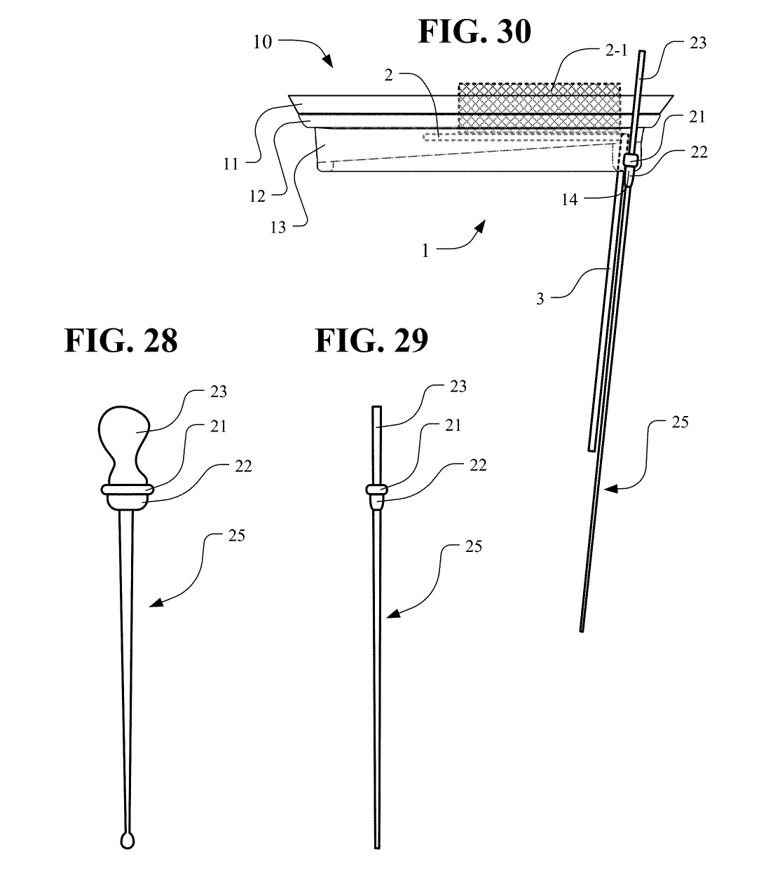

In FIG. 28, a front view of a stirring rod 25 is shown. The stirring rod 2 includes a handle 23, a first ridge 21 and a third ridge 22. The stirring rod 25 is designed to fit in the sipping hole 14 as shown in FIG. 21 and FIG. 22.

In FIG. 29, a side view of the stirring rod 25 of FIG. 28 is shown including the handle 23, the first ridge 21 and the third ridge 22. The stirring rod 25 has a taper to a smaller dimension the farther from the ridge 22.

In FIG. 30, a front view of the inverted cover 10 of FIG. 20 together with the manufacture 1 of FIG. 9 and the stirring rod 25 of FIG. 29. Both the tail 3 of the manufacture 1 and the stirring rod 25 of FIG. 28 and FIG. 29 extend through the hole 14 in cover 10. When the stirring rod 25 is forced all the way into the hole 14, the tail 23 is tightly compressed so that little or no water is transported by the tail. Because the stirring rod 25 is tapered, as the stirring rod 25 is partially withdrawn, less compression occurs against the tail 3. Accordingly, positioning the location of the stirring rod more or less into the hole 14 allows the amount of water carried by the tail 3 to be controlled.

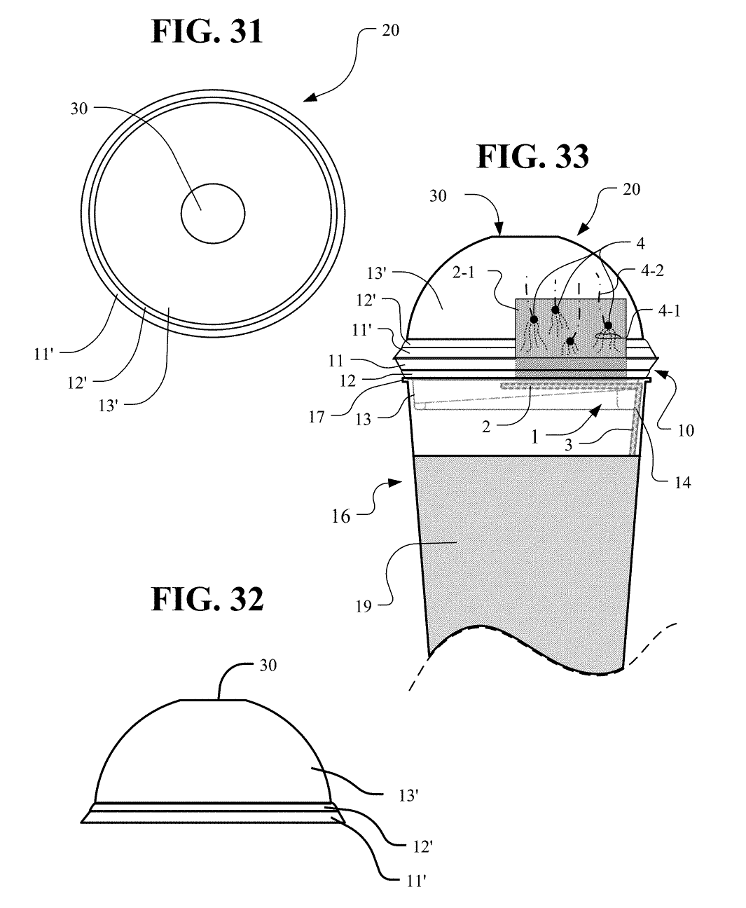

In FIG. 31, a top view of another cover 20 is shown. The cover 20 includes a first rim 11′, a second rim 12′ and an inner top 13′. The inner top 13′ includes a sipping hole 30 less than approximately 1 inch in diameter. The first rim 11′ and the second rim 12′ are formed to provide a seal on a matching cup such as the cup 16 of FIG. 22 in the same that the rims 11 and 12 of cover 10 form a seal.

In FIG. 32, a front view of the cover 20 of FIG. 31 is shown including the first rim 11′, the second rim 12′ and the inner top 13′with a sipping hole 30.

In FIG. 33, a front view of a cup 16 with the inverted cover 10 and the manufacture 1 as shown in FIG. 26 together with the cover 20 of FIG. 33 over the cover 10.

In FIG. 34, a front view of the cup 16 of FIG. 22, the inverted cover 20 of FIG. 32 and the manufacture 1 of FIG. 8 are shown. The first rim 11′ and the second rim 12′ prevent manufacture 1 from sliding into cup 16 other than the tail 3.

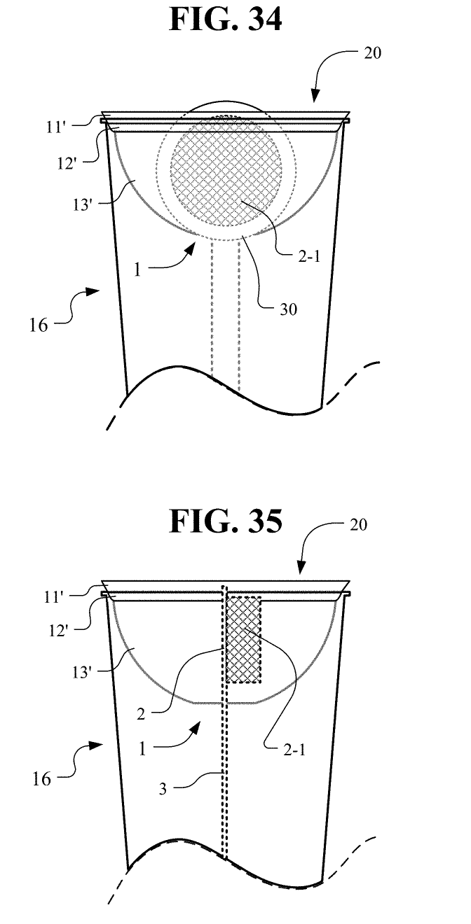

In FIG. 35, a side view of the cup 16, the inverted cover 20 and the manufacture 1 of FIG. 34 are shown.

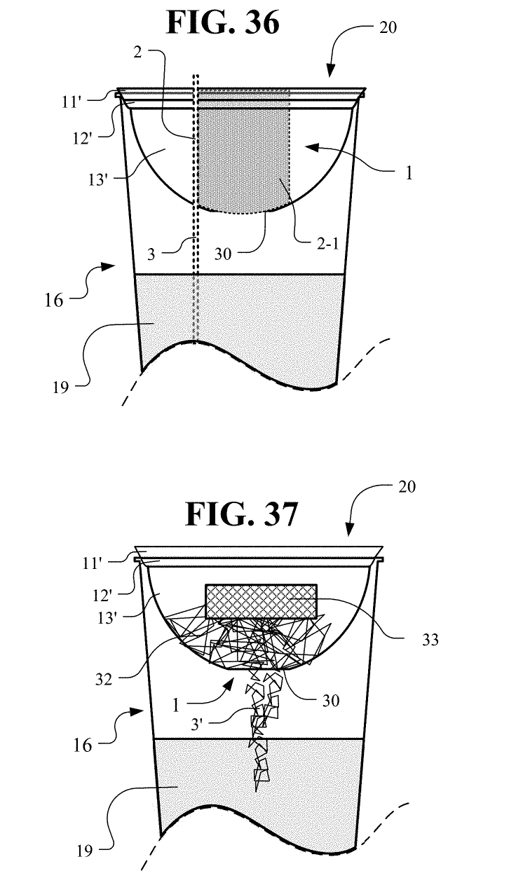

In FIG. 36, the side view of the cup, the inverted cover and the manufacture 1 of FIG. 35 with the manufacture 1 expanded through action of the water 19 transported through tail 3.

In FIG. 37, a front view of the cup 16 of FIG. 22, the inverted cover 20 of FIG. 32, a napkin 32 and a soil packet 33 is shown. The napkin 32 prevents the soil packet 33 or alternately loose soil, as shown in FIG. 27, from falling through the hole 30 into the cup 16. The napkin 32 includes a torn or small piece 3′ that functions as a tail for transporting water 19 to the soil packet 33. The soil packet typically has embedded seeds.

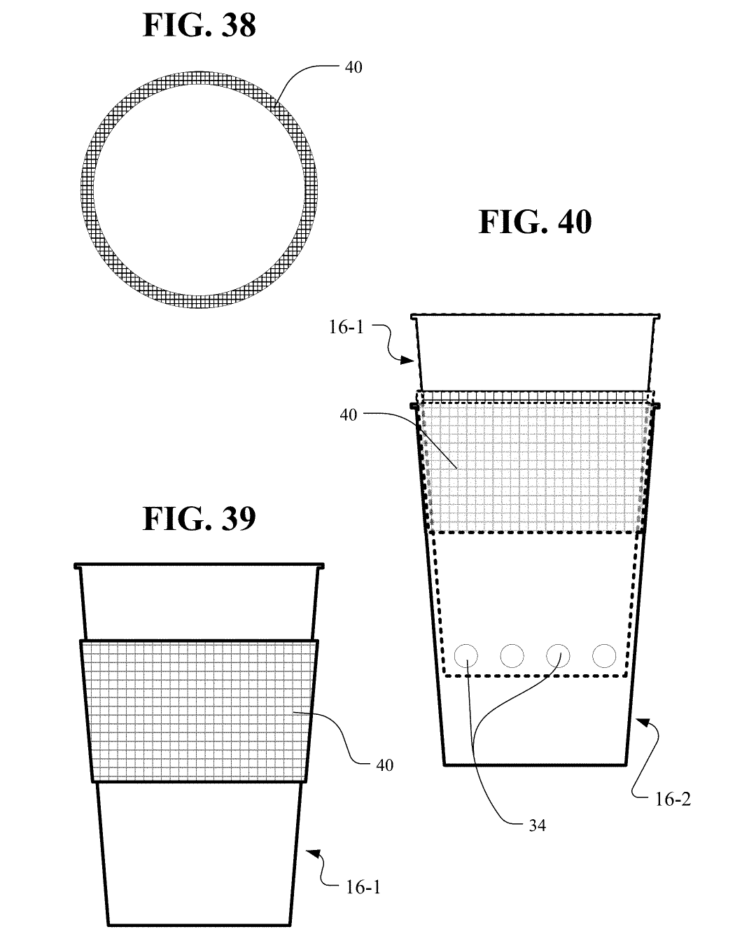

In FIG. 38, a top view of an insulating sleeve 40 for use with a cup of the FIG. 22 type.

In FIG. 39, a front view of a cup 16-1 together with the insulating sleeve 40 of FIG. 38 are shown.

In FIG. 40, a front view of the cup 16-1 and the insulating sleeve 40 of FIG. 39 are shown positioned in another cup 16-2. The sleeve 40 prevents the cup 16-1 from sliding to the bottom of cup 16-2. Typically, cup 16-1 is filled with dirt and serves as a secondary container suitable for receiving germinated plants of the type shown in FIG. 26 and FIG. 33 that require more dirt. Typically holes 34 are punched in the bottom of cup 16-1 to allow drainage of excess water into cup 16-1 which holds the excess water.

While the invention has been particularly shown and described with reference to preferred embodiments thereof it will be understood by those skilled in the art that various changes in form and details may be made therein without departing from the scope of the invention.

1. A manufacture for nurturing plants from a propagative source, comprising, a holder for holding the propagative source, a tail extending from the holder for feeding water to the holder and the propagative source.

2. The manufacture of claim 1 wherein the holder holds one or more seeds as the propagative source.

3. The manufacture of claim 2 wherein the holder includes soil.

4. The manufacture of claim 2 wherein the holder includes a packet containing soil.

5. The manufacture of claim 1 wherein the manufacture is positioned in a cover for a cup where the cover has a hole and where the tail extends through the hole and into the cup.

6. The manufacture of claim 5 wherein the cup contains water and wherein the tail extends through the hole into the water whereby water is fed to holder for germinating the propagative source.

7. The manufacture of claim 6 wherein a stirrer is inserted into the hole for controlling the flow of water.

8. The manufacture of claim 1 wherein the manufacture is positioned in a cover for a cup where the cover is inverted so as to support soil and so as to support the manufacture and where the cover has a hole and where the tail extends through the hole and into the cup.

9. The manufacture of claim 8 wherein a napkin is placed on a surface of the cover where a portion of the napkin protrudes through the hole.

10. The manufacture of claim 1 wherein the tail contains fertilizer for feeding a plant germinated from the propagative source.
